(19) United States
(12) Patent Application Publication
(10) Pub. No.: US 2025/0349221 A1
(43) Pub. Date: Nov. 13, 2025

(54) STUDENT-INFORMED GENERATIVE EDUCATION PLATFORM

(71) Applicant: Toyota Research Institute, Inc., Los Altos, CA (US)

(72) Inventors: Monica Van, Palo Alto, CA (US); Scott Carter, San Jose, CA (US); Nayeli Bravo, Salinas, CA (US)

(73) Assignees: Toyota Research Institute, Inc., Los Altos, CA (US); Toyota Jidosha Kabushiki Kaisha, Toyota-Shi Aichi-Ken (JP)

(21) Appl. No.: 18/656,717

(22) Filed: May 7, 2024

(51) Int. Cl. G09B 5/02; G06N 20/00

(52) U.S. Cl. CPC G09B 5/02; G06N 20/00

(57) ABSTRACT

Certain aspects of the disclosure pertain to a student-informed generative education platform. Students' interaction with a social media network can be analyzed using natural language processing to build profiles capturing individual interests, perspectives, and sentiments. A generative machine learning model can be employed that is trained to generate an educational challenge based on a curriculum goal input by an instructor and a student profile. The educational challenges are tailored for each student based on the student's background. Feedback loops can be employed to continuously refine generated educational challenges from the generative machine learning model based on monitoring student engagement.

### TECHNICAL FIELD

Aspects described herein relate to generative machine learning. More specifically, aspects pertain to an electronic platform that utilizes machine learning to automatically generate challenges based on goals and individual profiles.

### BACKGROUND

Traditional educational platforms provide tools to facilitate instruction and learning through course management features. Teachers can upload course information, assignments, and grades for students to access electronically. Conventional education platforms often feature classroom spaces where teachers can post announcements and materials. Students can check grades, obtain course information, and submit work to a teacher through the platform.

### SUMMARY

According to one aspect, a method is disclosed comprising collecting social media data from a social media network for a plurality of students, saving the social media data with demographic data in a student profile for each student in a student profile database, receiving a curriculum goal from an instructor, selecting a group of two or more students, executing a machine learning model that generates a challenge based on the curriculum goal, and the student profile for each student in the group, and distributing the challenge to each student in the group through a content delivery platform.

In accordance with another aspect, a method is disclosed comprising receiving social media posts from a social media network service for a plurality of students associated with an instructor, saving the social media posts with demographic data in a student profile for each of the plurality of students in a non-volatile data repository, executing a machine learning model trained to generate a challenge based on a curriculum goal provided by the instructor and the student profile of each student in the plurality of students in which the challenge addresses the curriculum goal in a context that is relatable to the plurality of students based the student profile of each of the plurality of students, distributing the challenge to each student through a content delivery platform, collecting feedback from student engagement with the challenge, and communicating the feedback to the instructor through an instructor interface of the content delivery platform.

Other aspects provide systems associated with the aforementioned methods; non-transitory, computer-readable media comprising instructions that, when executed by a processor of a processing system, cause the processing system to perform the methods; and a computer program product embodied on a computer-readable storage medium comprising code for performing the aforementioned methods as well as those further described herein.

The following description and the related drawings set forth in detail certain illustrative features of one or more aspects of this disclosure.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an example implementation of an education platform according to one or more embodiments shown and described herein;

FIG. 2 illustrates an example student interface according to one or more embodiments shown and described herein;

FIG. 3 is a flow diagram of an example method of challenge generation according to one or more embodiments shown and described herein;

FIG. 4 is a flow diagram of an example method evaluating challenge engagement according to one or more embodiments shown and described herein.

FIG. 5 is a block diagram of an example operating environment within which aspects of the subject disclosure can be performed according to one or more embodiments shown and described herein.

### DETAILED DESCRIPTION

Aspects described herein provide apparatuses, methods, processing systems, and computer-readable mediums for student-informed generative education through machine-learning-generated challenges.

An educational platform is an online tool or software that facilitates the delivery of educational content and supports the learning process. The educational platform provides a virtual environment that allows instructors and students to access educational materials and track progress. However, the flow of information is typically one-directional from an instructor to students, and student feedback is typically provided out-of-band by electronic mail. Further, conventional platforms are substantially static and rely on manual mechanisms to produce educational content for a class of students. Furthermore, the educational content produced is often generic and unrelatable as it is designed for substantially anyone.

Aspects described herein provide technical improvements to traditional educational platforms. In accordance with one embodiment, a social media network service is provided to students of a class. Data can be extracted from social media input through natural language and, optionally, image processing. Student profiles can be generated based on the extracted data and demographic data, among other things. A generative machine learning model can be trained on student profiles and instructor input (e.g., curriculum) to automatically generate challenges (e.g., problems, activities, assessments) tailored to each student. Further, feedback enables the refinement of the machine-learning model content based on student engagement and sentiment associated with challenges. In one instance, engagement can involve social media posts, interaction with the challenge or other students regarding the challenge, and facial expressions. Continuous optimization enhances learning personalization and better relates curriculum to diverse students, experiences, and viewpoints through an intelligent data-driven approach.

The following describes these systems and methods in more detail with reference to the drawings and where like numbers refer to like structures.

### Example Implementation of an Educational Technology Platform

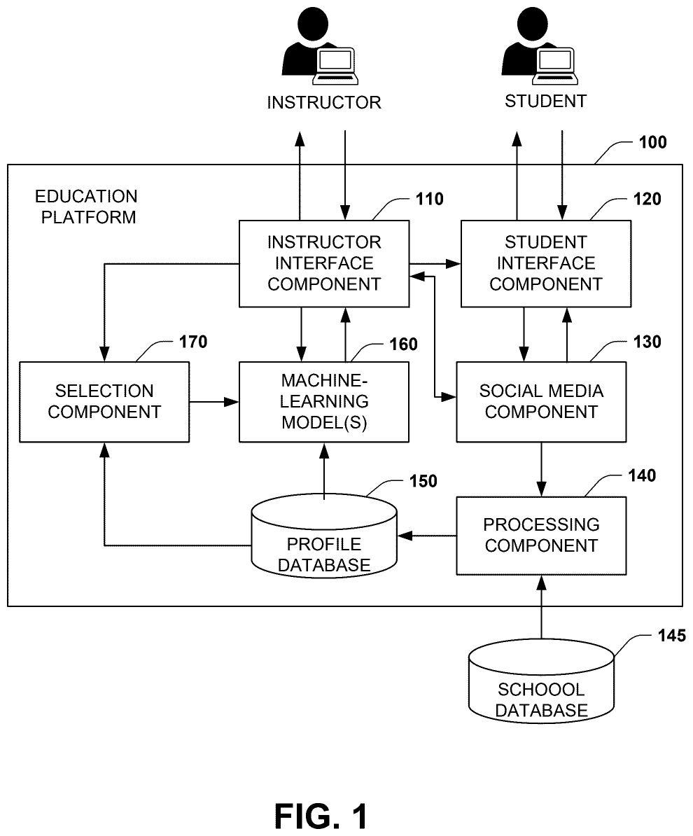

FIG. 1 depicts a high-level overview of an example implementation of aspects associated with an educational technology platform 100. The educational technology platform 100 can be a network accessible (e.g., online) system or service configured to engage students from varied backgrounds with a data-driven approach that employs generative machine learning to produce educational content automatically based on input from an instructor and a student profile. Further, the sentiment regarding the educational content can be monitored and utilized to enable continuous refinement of educational content tailored to each student or group of students. The example implementation includes instructor interface component 110, student interface component 120, social media component 130, processing component 140, profile database 150, machine learning model(s) 160, and selection component 170. The instructor interface component 110, student interface component 120, social media component 130, processing component 140, machine learning model(s) 160, and the selection component 170 can be implemented by at least one processor coupled to at least one memory that stores instructions that, when executed by the at least one processor, cause the processor to perform the functionality of each component when executed. Consequently, a computing device can be configured to be a special-purpose device or appliance that implements the functionality of the educational technology platform 100. Further, all or portions of the educational technology platform 100 can be distributed across computing devices or made accessible through a network service.

The instructor interface component 110 is a user interface that enables interactions between a human and a computing device. Further, the instructor interface 110 can be a graphical user interface (GUI) in one embodiment. In this instance, the human can correspond to an instructor, teacher, or educator of students. The instructor can provide input to the educational technology platform 100 through the instructor interface component 110, including a curriculum goal and the identity of students. An instructor can also employ the instructor interface 110 to provide feedback regarding automatically generated challenges and monitor social network posts by students. Furthermore, the instructor can provide information, for example, regarding student scores and assessments.

The student interface component 120 is also a user interface that allows interactions between a human, namely a student, and a computing device, and, in one embodiment, the student interface 120 can comprise a graphical user interface (GUI). A student can receive and interact with educational challenges through the student interface component 120. Further, the student can communicate with other students and the instructor through a social network service accessible through the student interface 120.

The social media component 130 is configured to provide a social network service for students and instructors. A social network service is an online platform allowing individuals to create profiles, connect with others, and share content. Sharing can be in messaging, including text and emojis, photographs, and videos. Students can interact with the social media component 130 and service through the student interface component 120. Likewise, instructors can interact with the social media component 130 through the instructor interface component 110. The social media component can enable communication between students or groups of students. The social media component 130 can enable communication monitoring to determine student sentiment, interest and engagement with educational content and challenges to facilitate tailored instruction and grouping of students. In accordance with one embodiment, the social media component 130 and associated functionality can be restricted to a particular class, grade, school, or institution for at least privacy purposes. For example, a student can include an active social media account for one or more enrolled classes. In one embodiment, each class may be a particular group within which a student can interact with the instructor and other classmates.

The processing component 140 is configured to receive, process, and save data to a profile in the profile database 150. The processing component 140 can access and extract data regarding a student from the social media component 130. Data can include social media profile data provided by the student, posts, engagements, and interactions with teachers or other students. In accordance with one embodiment, natural language processing can be performed on text interaction to aid the performance of sentiment analysis for educational content, such as an automatically generated challenge, for example, to determine positive, negative, or neutral sentiment. Furthermore, natural language processing alone or combined with image processing can extract meaning or sentiment from an emoji or meme.

The processing component 140 can also receive, retrieve, or otherwise acquire data from a school database 145. The school database 145 can correspond to a central repository of information for an educational institution. The school database 145 can include student information (e.g., name, contact information, gender, parent information, special needs information), teacher information (e.g., name, qualifications, teaching assignment), grades and academic records, and financial information (e.g., fees, payments, grants). The processing component 140 can utilize at least a subset of data regarding a student from the school database 145 to create a student profile. Alternatively, the processing component 140 can incorporate social media data into a student profile provided by the school database 145.

The profile database 150 can be a non-volatile data repository. The profile database can comprise a structured collection of data organized and stored to facilitate efficient retrieval, updating, and management. According to one embodiment, the profile database can comprise a table with rows where each row represents an individual profile and columns correspond to specific characteristics of an individual, such as name, gender, age, grade, interests, likes, and dislikes. Further, the profile database 150 can be implemented using a database management system that provides tools for creating, querying, and modifying data, among other things.

The machine learning model(s) 160 receives input from an instructor regarding curriculum or a curriculum goal (e.g., lesson plan) and profile data for the instructor's students and automatically generates one or more educational challenges. An educational challenge is a problem, activity, question, or other assessment. Example challenges include word problems, puzzles, and games. After training based on instructor objectives and student profiles, the machine learning model dynamically creates one or more educational challenges tailored to a student. Accordingly, the machine learning model(s) 160 can be a generative machine learning model that enables content creation including one or more educational challenges.

The machine learning model(s) 160 can generate text, speech, images, and videos, among other things. For example, generative text can be used to create word problems, while images or videos can be associated with puzzles or games. In some embodiments, a machine learning model can correspond to a generative pre-trained transformer (GPT) series model or a recurrent neural network (RNN) for generating text. Variational autoencoders (VAE), generative adversarial networks (GAN), or both can generate images and video. In accordance with one embodiment, multiple machine learning models 160 can be employed, for example, to generate different types of educational challenges.

After generating an educational challenge, the machine learning model(s) 160 can output the challenge to an instructor through the instructor interface component 110. The instructor can evaluate the challenge for appropriateness and comprehensibility, and provide the challenge to a student through the student interface component 120. If the challenge is unacceptable as generated, the instructor may modify the challenge before assigning the challenge to a student. Alternatively, the instructor may request output of another challenge by the machine-learning model(s) 160. Further, the instructor can provide feedback regarding the educational challenge to the machine learning model(s) to facilitate subsequent fine-tuning of a machine learning model.

For example, consider a single math student who complains on social media about helping their parents recycle business after school by posting satirical memes about the number of cans the student has to go through every day. The processing component 140 can extract this context data and save the data in the student's profile. The machine learning model(s) 160 can be employed to generate a math word problem for the student based on the student's profile and instructor input. Suppose the instructor notes the class is currently studying rates. In response, the machine learning model(s) 160 can generate the following word problem for the student, “If A recycles 1000 aluminum cans by hand in 20 minutes, how long would it take for A to recycle 1,000,000 cans by hand?”

The selection component 170 is configured to select a group of two or more students. In accordance with one embodiment, the selection component can select a group of two or more students based on a diversity specified in the profile database 150. For example, students with different backgrounds can be paired together. Pairing diverse students is beneficial for many reasons. In one instance, pairing diverse students can encourage a discussion that enriches the curriculum by incorporating multiple viewpoints and contexts. For example, students may be exposed to a new perspective on a problem they may not have considered from other students' points of view, enhancing critical thinking skills. Further, cross-background groupings can provide nuanced insights into challenges. In one instance, an instructor may provide input into the selection component 170 through the instructor interface component 110. For example, the instructor may identify student pairings to override selection. Alternatively, the instructor can prioritize selection based on a particular factor. The selection component 170 can identify a group of students to the machine learning model(s) 160.

The machine learning model(s) 160 can be trained to generate an educational challenge based on profiles of multiple students in a group. Further, the machine learning model(s) 160 can be trained to generate challenges with a context relevant to at least one student in the group. In one particular embodiment, the machine learning model(s) can be trained to generate challenges based on a relevant context or interest to all students in a group. Consider a group of two students with diverse backgrounds. For example, suppose a first student comes from a family of parents who are chemists and a second student comes from a family with parents who own a restaurant. Based on this information, the machine learning model(s) 160 can generate an educational challenge in the context of food science, as that would likely be of interest to both students.

Consider another example scenario in which the recycle word problem, previously described, is provided to a first student and a second student of opposite socioeconomic status. The second student may object to the question's premise and ask why ‘A’ recycles cans by hand when they can recycle a lot more with a recycling machine through social media communication. The first student could respond that a recycling machine is very expensive and may not be available to everyone. The first student could also note that if A continues recycling by hand, he will become faster after recycling 200 cans. This additional input can be taken as feedback and used by the generative machine learning model and can generate additional problems to solve, such as “‘A’ can recycle 1000 aluminum cans by hand in 20 minutes and earns $5. ‘A’ would be able to recycle cans 10% faster after having recycled 200 cans. Switching to a recycling machine would speed up the process by 40% but cost $500. How many cans would ‘A’ have to recycle before they would break even on buying a recycling machine?” In one embodiment, a prompt, generated based on student feedback, can be added to input to the generative machine learning model to guide or influence the model to produce one or more additional problems. These additional problems can be provided to an instructor who could select one to override an original problem.

### Example Student Interface Component

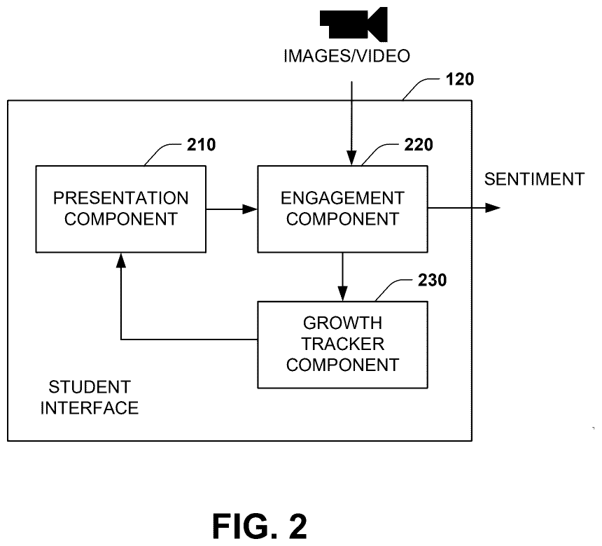

Turning to FIG. 2, an example student interface component 120 is illustrated in further detail in accordance with one embodiment. The student interface component 120 comprises presentation component 210, engagement component 220, and growth tracker component 230. Although these components are presented within the student interface component 120, at least a subset of the components can be external to the student interface component 120 as part of the education technology platform 100.

The presentation component 210 is configured to render or display visual information to students in a structured and meaningful manner. The presentation component 210 can structure and display diverse content types and employ layout and graphical representation techniques to optimize information comprehension and user engagement. Further, the presentation component 210 can adapt to varying screen sizes and device types to ensure usability across platforms. Furthermore, one or more optimization strategies (e.g., caching) can be implemented by the presentation component 210 to minimize latency and enable seamless interaction. The presentation component 210 can render or display a generated educational challenge in one embodiment. In response to the presentation of the educational challenge or before such a presentation, the engagement component 220 can be initiated.

The engagement component 220 seeks to monitor and capture data on student engagement with the educational challenge. In one embodiment, a student's sentiment regarding the educational challenge can be determined. After receiving and viewing an educational challenge, a student may engage in social network communication with other students regarding the student's view, opinion, or attitude as it pertains to the educational challenge. Accordingly, after presenting an educational challenge, the engagement component can monitor social media input through the student interface 120 and perform sentiment analysis to determine a student's opinion regarding an educational challenge. Sentiment analysis can employ lexical analysis, machine learning, and deep learning techniques to determine sentiment associated with text, emojis, or memes in social media posts. The engagement component 220 can seek to determine and monitor sentiment from initial presentation of the educational challenge to submission of a response. Such information can be useful regarding initial responses and potential nuances associated with solving the educational challenge.

Per one embodiment, the engagement component 220 can also exploit the availability of a computing device camera to aid in understanding user sentiment. For example, before presenting an educational challenge, a camera can be activated to capture images or video of a student's facial expression or body language associated with an educational. A combination of computer vision, machine learning, and deep learning techniques can be utilized to recognize emotions from images or videos of a student. For example, with respect to detecting emotions from images of facial expressions, a first step can be to utilize deep learning detectors such as a convolutional neural network to identify a face within an image or video frame. Once a face is detected, feature extraction can be performed to identify regions of the face that represent various facial expressions. Finally, a machine learning model can be trained to classify emotions based on the features.

Consider a situation in which a first student is solving an educational challenge with a second student, and the first student is surprised or intrigued by input provided by the second student. The surprised emotion can be detected based on a facial expression. In this situation, the surprise may indicate that the first student learned something unexpected from engaging with the second student. Such a sentiment can provide valuable feedback to an instructor and the machine-learning model regarding the quality of the challenge, the pairing of students, or both. Furthermore, the same sentiment can indicate an additional takeaway outside a particular curriculum skill.

The growth tracker component 230 is configured to measure and display, through the presentation component 210, personal growth of an individual student. The growth tracker component 230 highlights student contribution to formulating the educational challenge and proposed solution through feedback as well as additional takeaways learned outside the curriculum. In accordance with one embodiment, the growth tracker component 230 can provide a data visualization of the students' engagement on the platform, with other students, and with the questions. For example, an input could be the number of times a student comments on the assigned problems or to capture surprise when the student reacts with certain emojis to an assigned question. Inputs aside from the students' user interactions on the platform would be web camera inputs and audio/mic inputs. If enabled, these could act as weights for the user interactions, For instance, a surprised emoji reaction paired with an audible exclamation would be ranked higher when displayed to the student. The output of the growth tracker component 230 can be an individual module on the social learning platform, where the student can view a summary of what they learned, as well as a list of their engagements that have been classified by a machine learning model as “surprise” and therefore worth reminding the students of in their recap.

### Example Methods of Educational Challenge Generation and Engagement

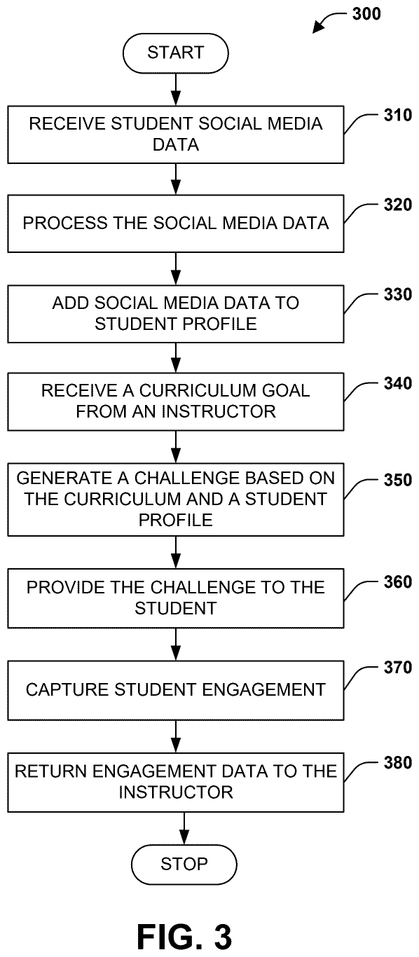

Turning to FIG. 3, an illustrative flow diagram depicts an example method 300 for generating an educational. The method 300 can be executed by the components of the educational technology platform 100 of FIG. 1.

The method 300 starts at block 310 by receiving student social media data. A social media service can be provided and utilized by a student to communicate with classmates and instructors. Communication can be regarding classwork or other topics of interest to the student. In one instance, an instructor can request that a student post regarding activities of interest to acquire additional context data. Additionally, or alternatively, the instructor can generate posts and receive student feedback.

The method 300 continues at block 320 by processing the social media data. Social media data posted by a user can be monitored and processed. In one embodiment, natural language processing techniques can be utilized to extract context information from text. Further processing can employ image processing to extract context from emojis or memes, for example. In one instance, context can include sentiment regarding a variety of topics.

The method 300 continues at block 330 by adding context extracted from social media data to a student profile. A student profile can be generated for a student based initially on student information from a school or institute database. The student profile can then be continually enhanced based on social media interaction.

The method 300 next proceeds at block 340 by receiving a curriculum goal from an instructor through an instructor interface. The curriculum goal can be an educational objective that outlines what students should learn. In one embodiment, the curriculum goal can be a lesson plan, which breaks the curriculum goal down into smaller units of instruction. Each lesson plan can be designed to make progress toward achieving the broader curriculum goal.

The method 300 continues at block 350 by generating an educational challenge based on the curriculum goal and the student profile. In accordance with one embodiment, a machine learning model can be executed that is trained to automatically generate an educational challenge, such as a word problem, puzzle, or game based on the curriculum goal and the student profile.

The method 300 proceeds at block 350 by providing an educational challenge to the student. The educational challenge can initially be provided to the instructor through the instructor interface. The instructor can then evaluate the educational challenge to ensure it is appropriate and comprehensible. The instructor can optionally update or change the educational challenge as desired and assign the educational challenge to a student.

The method 300 continues at block 370 by capturing student engagement with the content. In accordance with one embodiment, student engagement can include sentiment regarding the educational challenge. Sentiment can be determined by analyzing social media posts or interactions with sentiment analysis techniques. Further, a camera can be triggered, and sentiment can be determined based on an analysis of facial expressions or body language in an image or video frame. Student engagement can also correspond to an answer to the educational challenge.

The method 300 next continues at block 380 by returning engagement data, including the response to the challenge, to the instructor for evaluation. Subsequently, the method 300 terminates.

Note that FIG. 3 is just one example of a method, and other methods including fewer, additional, or alternative steps are possible consistent with this disclosure.

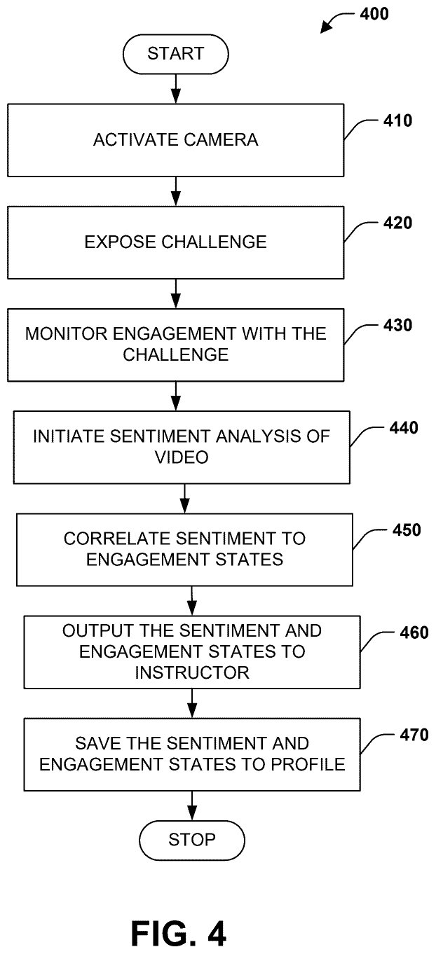

FIG. 4 depicts an illustrative flow diagram of an example method 400 for determining student sentiment regarding an educational challenge. The method 400 can be executed by the education technology platform 100 of FIG. 1 and, in one embodiment, the engagement component 220 of FIG. 2.

The method 400 starts at block 410 by activating a camera. The camera can capture images, video, or both. In accordance with one embodiment, the camera can correspond to a web camera integrated or otherwise attached to a student computing device.

The method 400 continues at block 420 by exposing or presenting an educational challenge to a student through a student interface. The educational challenge can be a word problem, puzzle, or game, among other things. Further, a machine learning model can automatically generate the educational challenge based on a curriculum goal or lesson plan and a student profile supplemented with context extracted from a social media service.

The method 400 next proceeds to block 430 by monitoring engagement with the educational challenge. Engagement can include various states including initial review, discussion with others, generating a response, and submitting a response to the educational challenge, among other things.

The method 400 continues to block 440 by initiating sentiment analysis with respect to a video or series of images. The sentiment can be positive, negative, or neutral. Additionally, the sentiment can correspond more specifically to an emotional state, such as being surprised, frustrated, happy, mad, or sad. In accordance with one aspect, sentiment can be determined based on facial or body language analysis. In one instance, the sentiment analysis can be triggered after a student submits a response to the challenge. However, sentiment can be triggered before the response is submitted and performed in real time while a student is engaged with an educational challenge.

The method 400 proceeds to block 450 by correlating sentiment with engagement states. Since sentiment can change from the initial review of an educational challenge through the submission of a response, the sentiment determined by sentiment analysis can be correlated based on time to different engagement states.

The method 400 continues to block 460 by outputting the sentiment and engagement states to the instructor. The instructor can utilize this information to determine if a topic or concept needs further exploration.

The method 400 finally moves to block 470 by saving sentiment and engagement states to a student profile. This information can be utilized to fine-tune a machine learning model or track educational growth over time.

Note that FIG. 4 is just one example of a method, and other methods including fewer, additional, or alternative steps are possible consistent with this disclosure.

### Example Processing System for Aspects of an Education Platform

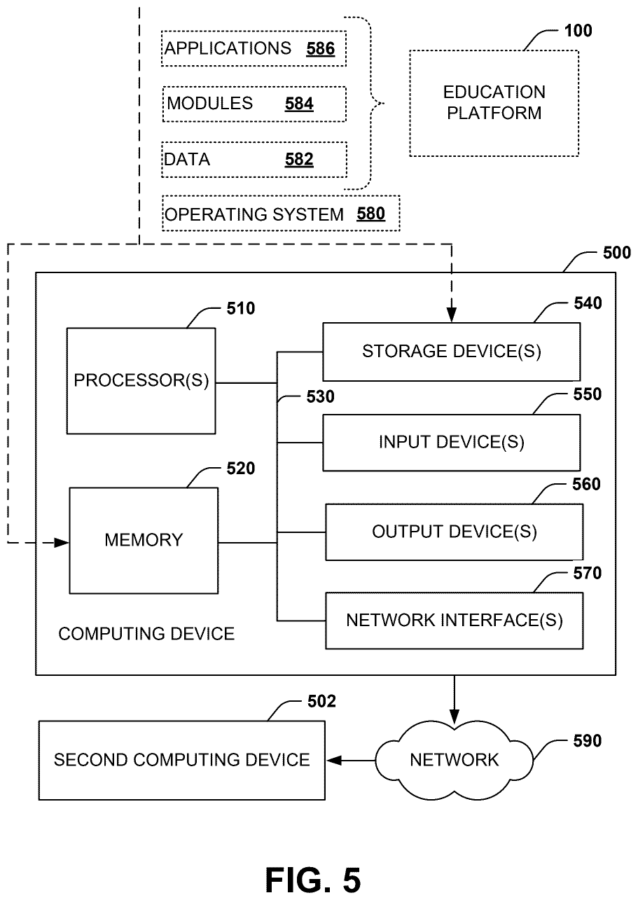

FIG. 5 depicts an example processing system configured to perform various aspects described herein, including, for example, methods as described above with respect to FIGS. 3 and 4.

To provide a context for the disclosed subject matter, FIG. 5, as well as the following discussion, are intended to provide a brief, general description of a suitable environment in which various aspects of the disclosed subject matter can be implemented. A suitable environment is solely an example and is not intended to suggest any limitation on the scope of use or functionality.

With reference to FIG. 5, an example computing device 500 is illustrated. The computing device 500 includes one or more processor(s) 510, memory 520, bus 530, storage device(s) 540, input device(s) 550, output device(s) 560, and network interface(s) 570. The bus 530 communicatively couples at least the above system constituents. However, the computing device 500, in its simplest form, can include one or more processors 510 coupled to at least one memory 520, wherein the one or more processors 510 execute various computer-executable actions, instructions, and or components stored in the memory 520 and retrieved from storage devices 540.

The bus 530 may be formed from any medium capable of transmitting a signal, such as conductive wires, conductive traces, optical waveguides, connectors, or the like. In one embodiment, the bus 530 comprises a combination of conductive traces, conductive wires, connectors, and cooperate to permit the transmission of electrical data signals to components such as the processor(s) 510, memory 520, storage device(s) 540, input device(s) 550, output device(s) 560, and network interface(s) 570.

The processor(s) 510 can be implemented with a general-purpose processor, a microprocessor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. The processor(s) 510 can also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 510 can be a graphics processor unit (GPU) that performs calculations concerning digital image processing and computer graphics.

The computing device 500 can include or otherwise interact with a variety of computer-readable media to facilitate control of the computing device 500 to implement one or more aspects of the disclosed subject matter. The computer-readable media can be any available media accessible to the computing device 500 and includes volatile and non-volatile media and removable and non-removable media. Computer-readable media can comprise two distinct and mutually exclusive types: storage media and communication media.

Storage media includes volatile and non-volatile, removable, and non-removable media implemented in any method or technology to store information, such as computer-readable instructions, data structures, program modules, or other data. Storage media includes memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD)), and solid-state devices (e.g., solid-state drive (SSD), flash memory drive (e.g., card, stick, key drive)), or any other like mediums that store, as opposed to transmit or communicate, the desired information accessible by the computing device 500. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 520 and storage device(s) 540 are examples of computer-readable storage media. Depending on the configuration and type of computing device, the memory 520 can be volatile (e.g., random access memory (RAM)), non-volatile (e.g., read-only memory (ROM), flash memory . . . ), or some combination of the two. By way of example, the basic input/output system (BIOS), including basic routines to transfer information between elements within the computing device 500, such as during start-up, can be stored in non-volatile memory. By contrast, volatile memory can act as external cache memory to facilitate processing by the processor(s) 510, among other things.

The storage device(s) 540 include removable/non-removable, volatile/non-volatile storage media for storing vast amounts of data relative to the memory 520. For example, storage device(s) 540 include, but are not limited to, one or more devices such as a magnetic or optical disk drive, floppy disk drive, flash memory, solid-state drive, or memory stick.

Memory 520 and storage device(s) 540 can include, or have stored therein, operating system 580, one or more applications 586, one or more program modules 584, and data 582. The operating system 580 can control and allocate resources of the computing device 500. Applications 586 include one or both of system and application software and can exploit management of resources by the operating system 580 through program modules 584 and data 582 stored in the memory 520 and/or storage device(s) 540 to perform one or more actions. Accordingly, applications 586 can turn a general-purpose computer into a specialized machine according to the logic provided.

All or portions of the disclosed subject matter can be implemented using standard programming and/or engineering techniques to produce software, firmware, hardware, or any combination thereof to control the computing device 500 to realize the disclosed functionality. By way of example and not limitation, all, or portions of the education technology platform 100 of FIG. 1 can be, or form part of, the application 586 and include one or more modules 584 and data 582 stored in memory and/or storage device(s) 540 whose functionality can be realized when executed by one or more processor(s) 510.

In accordance with one particular embodiment, the processor(s) 510 can correspond to a system on a chip (SOC) or like architecture including, or in other words integrating, both hardware and software on a single integrated circuit substrate. Here, the processor(s) 510 can include one or more processors as well as memory, at least similar to the processor(s) 510 and memory 520, among other things. Conventional processors include minimal hardware and software and rely extensively on external hardware and software. By contrast, a SOC implementation of a processor is more powerful, as it embeds hardware and software therein that enable particular functionality with minimal or no reliance on external hardware and software. For example, the education technology platform 100 or functionality associated therewith can be embedded within hardware in a SOC architecture.

The input device(s) 550 and output device(s) 560 can be communicatively coupled to the computing device 500. By way of example, the input device(s) 550 can include a pointing device (e.g., mouse, trackball, stylus, pen, touchpad), keyboard, joystick, microphone, voice user interface system, camera, sensor, and a global positioning satellite (GPS) receiver and transmitter, among other things. The output device(s) 560, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 550 and output device(s) 560 can be connected to the computing device 500 by way of a wired connection (e.g., bus), wireless connection (e.g., Wi-Fi, Bluetooth), or a combination thereof.

The computing device 500 can also include network interface(s) 570 to enable communication with at least a second computing device 502 utilizing a network 590. The network interface(s) 570 can include wired or wireless communication mechanisms to support network communication. The network 590 can correspond to a personal area network (PAN), local area network (LAN), or a wide area network (WAN), such as the Internet. In one instance, the computing device 500 can correspond to a first computing device, such as a server, executing the education platform 100 or portions thereof. The second computing device 502 can correspond to an instructor or student personal computer that interacts with the education platform 100 over the network 590.

The functional blocks and/or flowchart elements described herein may be translated into machine-readable instructions. As non-limiting examples, the machine-readable instructions may be written using any programming protocol, such as: descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via cither a field programmable gate array (FPGA) configuration or an application-specific integrated circuit (ASIC) or their equivalents. Accordingly, the functionality described herein may be implemented in any conventional computer programming language, as pre-programmed hardware elements, or as a combination of hardware and software components.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various elements, steps, or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, method steps, and flow components described in the present disclosure may be implemented or performed with a general-purpose processor, a special-purpose processor (e.g., an artificial intelligence processor), combinations of general-purpose and special-purpose processors, and other programmable logic devices, or any combination thereof. A general-purpose processor may be a microprocessor, a commercially available processor, a controller, a microcontroller, or a state machine. A processor may also be implemented as a combination of computing devices.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, “real time” refers to processing with minimal and acceptable delay. The term emphasizes immediacy while recognizing that some level of latency exists in any system. The term practically targets a time frame imperceptible to a user or within the requirements of a particular application without requiring instantaneous or zero latency responses.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as one or more buses.

The methods disclosed herein comprise one or more actions for achieving the methods. The method actions may be interchanged without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to general and special purpose processors.

The following claims are not intended to be limited to the aspects shown herein, but are to be accorded the full scope consistent with the language of the claims. Reference to an element in the singular is not intended to mean only one element unless specifically so stated, but rather “one or more” elements. The subsequent use of a definite article (e.g., “the” or “said”) with respect to an element (e.g., “the processor”) is not intended to limit the claim to an interpretation requiring only a single element (e.g., “only one processor”) unless otherwise specifically stated. For example, reference to an element (e.g., “a processor,” “a controller,” “a memory,” “the processor,” “the controller,” “the memory,”), unless otherwise specifically stated, should be understood to refer to one or more elements (e.g., “one or more processors,” “one or more controllers,” “one or more memories,”).

The terms “set” and “group” in the claims are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system, a processing system, or an apparatus) to perform functions, one element may be configured to cause the other element to perform all functions, or more than one element may collectively be configured to cause the other element to perform the functions.

Unless specifically stated otherwise, the term “some” refers to one or more.

All structural and functional equivalents to the elements of the various aspects described throughout this disclosure that are known or later become known to those of ordinary skill in the art are intended to be encompassed by the claims. Moreover, nothing disclosed herein is intended to be dedicated to the public, regardless of whether such disclosure is explicitly recited in the claims.

1. A method, comprising:
training a machine learning model to generate educational challenges based on profiles of a plurality of students at an educational institution;
selecting a group of two or more students with diverse backgrounds from the plurality of students;
generating, using the machine learning model, an educational challenge based on a curriculum goal provided by an instructor and a context or interest relevant to all students in the group of two or more students;
presenting, by the machine learning model, the educational challenge to the group of two or more students through a student interface:
in response to presenting the educational challenge to the group of two or more students, collecting feedback regarding the educational challenge from engagement with the educational challenge by a student in the group of two or more students; and
fine-tuning the machine learning model based on the feedback regarding the educational challenge.

2. The method of claim 1, further comprising generating the profiles of the plurality of students, wherein generating the profiles of the plurality of students comprises:
acquiring student information, teacher information, academic records, and financial information for the plurality of students from a school database of the educational institution;
collecting social media data from a social media network for the plurality of students; and
saving the student information, the teacher information, the academic records, the financial information, and the social media data with demographic data in a corresponding student profile for each student in a student profile database.

3. The method of claim 1, wherein collecting feedback regarding the educational challenge from engagement with the educational challenge by the student comprises:
monitoring social media input through the student interface, wherein the social media input comprises one or more social media posts by the student; and
performing sentiment analysis on at least one of a text, an emoji, or a meme in the one or more social media posts to determine one or more sentiments regarding the educational challenge.

4. (canceled)

5. (canceled)

6. The method of claim 2, further comprising:
extracting, using a second machine learning model, content from one or more images in the social media data; and
adding the content to the social media data.

7. The method of claim 1, further comprising:
presenting, by the machine learning model, the educational challenge to the instructor through an instructor interface for approval before distributing the educational challenge; and
updating the educational challenge based on instructor feedback.

8. The method of claim 1, wherein collecting feedback regarding the educational challenge from engagement with the educational challenge by the student comprises:
capturing an image of the student solving the educational challenge with a second student in the group of two or more students;
detecting a face of the student in the image; and
classifying an emotion exhibited by the student based on one or more features extracted from the face of the student.

9. The method of claim 1, wherein collecting feedback regarding the educational challenge from engagement with the educational challenge by the student comprises:
capturing a video of the student interacting with the educational challenge; and
performing sentiment analysis on the video with a third machine learning model to determine one or more sentiments regarding the educational challenge.

10. (canceled)

11. A system, comprising:
at least one processor;
at least one memory coupled to the at least one processor that includes instructions that, when executed by the at least one processor, cause the system to:
train a machine learning model to generate educational challenges based on profiles of a plurality of students at an educational institution;
select a group of two or more students with diverse backgrounds from the plurality of students;
generate, using the machine learning model, an educational challenge based on a curriculum goal provided by an instructor and a context or interest relevant to all students in the group of two or more students;
present, by the machine learning model, the educational challenge to the group of two or more students student through a student interface;
in response to presenting the educational challenge to the group of two or more students collect feedback regarding the educational challenge from engagement with the educational challenge by a student in the group of two or more students; and
fine-tune the machine learning model based on the feedback regarding the educational challenge.

12. The system of claim 11, wherein the instructions further cause the system to:
acquire student information, teacher information, academic records, and financial information for the plurality of students from a school database of the educational institution;
collect social media data from a social media network for the plurality of students; and
save the student information, the teacher information, the academic records, the financial information, and the social media data with demographic data in a corresponding student profile for each student in a student profile database.

13. The system of claim 11, wherein the instructions further cause the system to:
monitor social input through the student interface, wherein the social media input comprises one or more social media posts by the student; and
perform sentiment analysis on at least one of a text, an emoji, or a meme in the one or more social media posts to determine one or more sentiments regarding the educational challenge.

14. (canceled)

15. (canceled)

16. The system of claim 12, wherein the instructions further cause the system to:
extract, using a second machine learning model, content from one or more images in the social media data; and
add the content to the social media data.

17. The system of claim 11, wherein the instructions further cause the system to:
capture a video of the student interacting with the educational challenge; and
perform sentiment analysis on the video with a third machine learning model to determine one or more sentiments associated with the interaction.

18. The system of claim 17, wherein the instructions further cause the processor to report the one or more sentiments associated with the interaction to the instructor.

19. A method, comprising:
receiving social media data from a social media network for a plurality of students associated with an instructor;
saving the social media data with demographic data in a student profile for each of the plurality of students in a non-volatile data repository;
training a machine learning model to generate educational challenges based on profiles of the plurality of students;
selecting a group of two or more students with diverse backgrounds from the plurality of students;
generating, using the machine learning model, an educational challenge based on a curriculum goal provided by the instructor, wherein the educational challenge addresses the curriculum goal in a context that is relatable to all students in the group of two or more students;
distributing, by the machine learning model, the educational challenge to the group of two or more students through a content delivery platform:
in response to distributing the educational challenge to the group of two or more students, collecting feedback regarding the educational challenge from engagement with the educational challenge by a student in the group of two or more students; and
fine-tuning the machine learning model based on the feedback regarding the educational challenge.

20. The method of claim 19, wherein collecting feedback regarding the educational challenge from engagement with the educational challenge by the student comprises:
recording a video of the student interacting with the challenge; and
performing sentiment analysis on the video to determine one or more sentiments regarding the educational challenge.

21. The method of claim 3, further comprising:
correlating the one or more sentiments with engagement states spanning from an initial review of the educational challenge through a submission of a response to the educational challenge; and
outputting the one or more sentiments and the engagement states to the instructor, thereby allowing the instructor to determine if a topic or a concept needs further exploration.

22. (canceled)

23. The method of claim 8, wherein the emotion exhibited by the student is surprised or intrigued by input provided by the second student, and further comprising:
updating the machine learning model in response to determining the student is surprised or intrigued by the input provided by the second student while the student is solving the educational challenge with the second student.

24. (canceled)

25. The method of claim 1, further comprising:
in response to presenting the educational challenge, outputting a summary of what the student learned in relation to the educational challenge, the summary including a list of engagements of the student that have been classified by the machine learning model as surprise.

26. The method of claim 19, wherein collecting feedback regarding the educational challenge from engagement with the educational challenge by the student comprises:
monitoring social media input through a student interface, wherein the social media input comprises one or more social media posts by the student; and
performing sentiment analysis on at least one of a text, an emoji, or a meme in the one or more social media posts to determine one or more sentiments regarding the educational challenge.

27. The method of claim 19, wherein collecting feedback regarding the educational challenge from engagement with the educational challenge by the student comprises:
capturing an image of the student solving the educational challenge with a second student in the group of two or more students;
detecting a face of the student in the image; and
classifying an emotion exhibited by the student based on one or more features extracted from the face of the student.
